(19) United States
(12) Patent Application Publication
(10) Pub. No.: US 2015/0006210 A1
(43) Pub. Date: Jan. 1, 2015

(54) TRANFERRING PLANNING DATA TO AN ENTERPRISE APPLICATION

(71) Applicants: Revati ANNA ELDHO, Bangalore (IN); Johannes Wienhold, Friedrichsdorf (DE); Jonathan Rhodes, London (GB); Sadaf Shakil, Jamshepur (IN); Reeneeth Das, Bangalore (IN); Seema Sachdeva, Bangalore (IN)

(72) Inventors: Revati ANNA ELDHO, Bangalore (IN); Johannes Wienhold, Friedrichsdorf (DE); Jonathan Rhodes, London (GB); Sadaf Shakil, Jamshepur (IN); Reeneeth Das, Bangalore (IN); Seema Sachdeva, Bangalore (IN)

(21) Appl. No.: 13/930,264

(22) Filed: Jun. 28, 2013

(51) Int. Cl. G06Q 10/06

(52) U.S. Cl. CPC G06Q 10/0631
USPC 705/7.12

(57) ABSTRACT

Various embodiments of systems and methods for transferring planning data of a plan are described herein. A data transfer request may be received to transfer the planning data included in the planning application. Next, based on the received request a data transfer option may be identified, from a plurality of data transfer options, to transfer the planning data. Finally, the identified data transfer option is executed to transfer the planning data to the enterprise application module.

### BACKGROUND

Several planning applications, for example Microsoft® Excel®, are popular as they allow a user to plan business projects. After the planning, the planning data received at the planning application has to be updated to an enterprise application, for example, an Enterprise Resource Planning (ERP) application. At present, a user has to manually update the enterprise application with the planning data received at the planning application. Manually updating planning data, to the enterprise application, is time-consuming and error-prone, which is undesirable.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating planning data transfer by a data transfer framework, according to an embodiment;

FIG. 2 is a block diagram illustrating planning data transfer by a data transfer framework, according to an embodiment;

FIG. 3 is a flow diagram illustrating a method to define a data transfer method, according to an embodiment;

FIG. 4 is a flow diagram illustrating a method to define a data transfer option, according to an embodiment;

FIG. 5 is a flow diagram illustrating a method of transferring planning data, according to an embodiment;

FIG. 6 is a flow diagram illustrating a method of transferring planning data by identified data transfer option, according to an embodiment;

FIG. 7 illustrates a user interface screen of an application for defining data transfer methods, according to an embodiment;

FIG. 8 illustrates a user interface screen of an application for defining a data transfer option, according to an embodiment;

FIG. 9 illustrates a planning application header including options to transfer planning data, according to an embodiment;

FIG. 10 is a block diagram illustrating a computing environment in which the techniques described for transferring planning data can be implemented, according to an embodiment.

### DETAILED DESCRIPTION

Embodiments of techniques for transferring planning data to enterprise application are described herein. In the following description, numerous specific details are set forth to provide a thorough understanding of embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

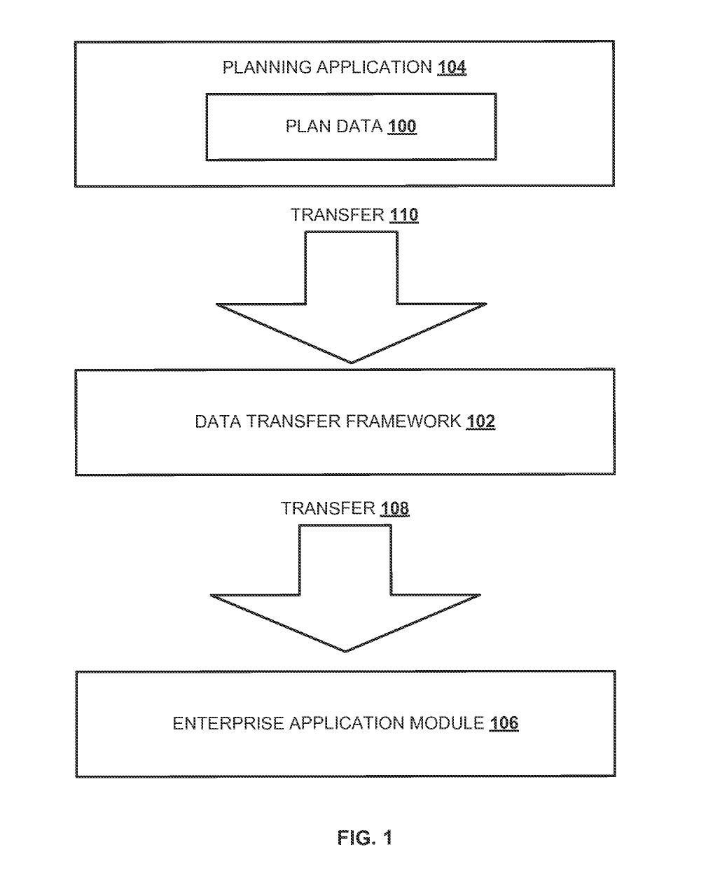

FIG. 1 is a block diagram illustrating planning data 100 transfer by a data transfer framework 102, according to an embodiment. Planning data 100 is data related to planning of a project. In one embodiment, project includes one or more tasks that are aimed at achieving a particular goal. Project planning includes defining required resources, planning resource quantity and/or other resource characteristics required for executing the project. In one embodiment, a planning application 104 allows a user to plan the project. The planning application 104 may display the project information, of a to-be-planned project, to a project planner. The project information may include, for example, the different tasks to be performed for executing a project. The project planner may then define planning resources and resource characteristics required for executing the project. The project information, the planning resources, and the planning resource characteristics, received at the planning application 104, may together form the planning data 100 of the project.

For example, consider that a project manager wants to build a campus of a company. In this case, “campus construction” is the project that is to be planned. Assume that two buildings are to be built in the campus. In this case, the project information that two buildings are to be built is received at the planning application. A project planner may then plan this project by defining planning resources such as, “construction workers”, “building material”, etc., required to construct the two buildings in the campus. A user may also provide quantities. “100 work hours” and “20000 pieces”, of the planning resources “construction workers” and “building material”, respectively, required for executing the project. The project information (two building for the campus), the planning resources (“construction workers” and “building material”) and the resource quantity (“100 work hours” and “20000 pieces”) may together form the planning data for the “campus construction” project.

The planning data 100 received at the planning application 104 is to be transferred to an enterprise application module 106. In one embodiment, the planning data 100 is transferred to the enterprise application module 106 to update the planning data 100 of the project received at the planning application 104 to the enterprise application module 106. In the above example, after planning application receives the planning data for the “campus construction” project, the planning data, e.g., planning resources (“construction workers” and “building material”) and the resource quantity (“100 work hours” and “20000 pieces”) has to be updated to the enterprise application module. In one embodiment, the enterprise application module 106 may also perform post-planning operations, for example, result analysis after receiving the planning data 100 from the planning application 104.

In one embodiment, a data transfer framework 102 transfers 108 planning data 100 from planning application 104 to the enterprise application module 106. The data transfer framework 102 is defined to retrieve 110 planning data 100 from the planning application 104 and then transfer 108 the retrieved planning data 100 to the enterprise application module 106. In the example described in previous paragraph, the data transfer framework 102 may be defined to retrieve the planning data 100, e.g., planning resources (“construction workers” and “building material”) and the resource quantity (“100 work hours” and “20000 pieces”), from the planning application and then transfer the retrieved planning data 100 to the enterprise application module 106. The data transfer framework 102 therefore allows transferring planning data 100 from the planning application 104 to the enterprise application module 106 without manual intervention and saves the user from effort of replicating data manually.

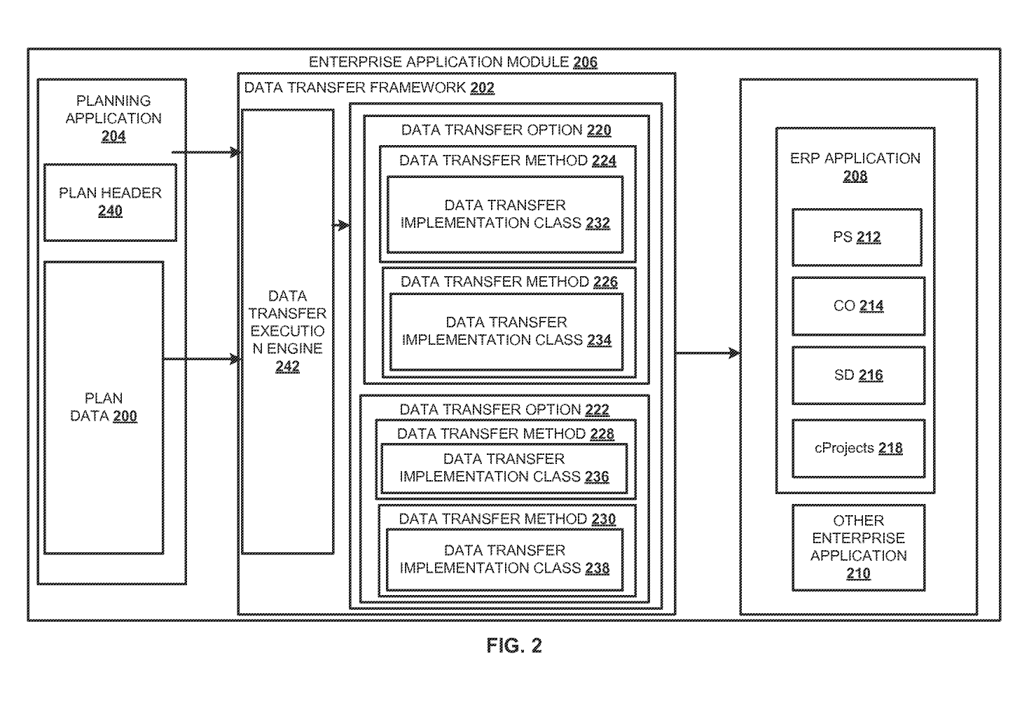

FIG. 2 is a detailed block diagram illustrating planning data 200 transfer by a data transfer framework 202, according to an embodiment. The planning data 200 may include data, received from a project planner, to execute a project. In one embodiment, the project, to be planned, may include several project objects. Project objects may represent a portion of the project. For example, a project may include several “work breakdown structure” (WBS) objects. Each of the WBS objects represents a portion of the project. For example, “sales order” may be a project object that represents a portion of a sales and distribution project. The different project objects may be grouped together according to their respective object type. For example, the different WBS objects can be grouped together according to the object type “WBS”.

In one embodiment, a planning application 204 may be used for planning the project. The planning application 204 may plan the project based on project information of the project, which is to be planned, and planning resources that may be used for executing the project. The project information may contain information related to the project objects included in the project. The information may include a unique identifier and a description of the project objects. The information may also include an object type of the different project objects. The planning resources may include, for example, “human resources”, “materials”etc. which may be used for executing the project. In the “campus construction” project example described with respect to FIG. 1, assume that the project manager wants to build two floors in building 1 and one floor in building 2. In this case, the “construction” project may include five WBS objects, which represent the two buildings and the three floors in the two buildings. In this case the unique identifiers for the two buildings may be X001 and X002. Further, the unique identifier for the two floor of building 1 may be X0011 and X0012. Similarly the unique identifier for the one floor in building 2 may be X0021. Some or all of the five WBS objects may have short description that describes the WBS object. For example, the WBS objects for building 1 may include a description “construction of building 1” for the building 1, “construction of floor 1 of building 1”, and “construction of floor 2 of building 1”. The unique identifier of the five project objects, the description, and the object type “WBS” of the five project objects may be used by the planning application for planning the project. Further, the planning resources, for example, “construction workers”, “project managers”. “building materials”, etc., may also be used by the planning application for planning the project.

In one embodiment, a user at the planning application may plan the project by selecting one or more planning resources for executing each of the projects objects of the project. The project planner may also provide a quantity for each of the selected planning resources. In one embodiment, the planning application 204 is a spreadsheet application, for example a Microsoft® Excel® workbook, which may allow a user to provide the planning data. The identification information of the project objects, including the project object type, the selected resources, the resource quantity, and any other information received from the user at the planning application 204, may together form the planning data 200 of the project. In the example described in the previous paragraph, the planning data 200 includes the identification information of the five project objects, the description of the five project objects, the object type “WBS” of the five project objects, the planning resources (“construction workers” and “building material”) and the resource quantity (“100 work hours” and “20000 pieces”).

The planning data 200 received at the planning application 204 has to be transferred to the enterprise applications module 206. In one embodiment, the enterprise application module 206 may include several enterprise applications. An enterprise application is an application that may be used for managing and performing day-to-day activity of an enterprise. For example, the enterprise application module 206 may include an Enterprise Resource Planning (ERP) application 208 and another enterprise application 210, for example, a Customer Relationship Management (CRM) application. In one embodiment, an application may include several sub-modules related to different organizational functions. For example, the ERP application 208 may include several ERP sub-modules, such as a project system (PS) sub-module 212, a control (CO) sub-module 214, sales and distribution (SD) sub-module 216, and a collaboration project (cProjects) sub-module 218.

In on embodiment, the planning data 200, received at the planning application 204, is to be transferred to one or more enterprise applications 208 and/or 210 in the enterprise application module 206. The planning data may also be transferred to one or more sub-modules 212, 214, 216, and 218 in the ERP application 208. The planning data 200 may be transferred to the enterprise application module 206 to update the planning data 200 received at the planning application 204 to the enterprise application module 206.

In one embodiment, the data transfer framework 202 includes one or more data transfer options 220 and 222 that may transfer the planning data 200 from the planning application 204 to the enterprise application module 206. Data transfer options 220 and/or 222 may be collections of data transfer methods 224, 226, and 228, 230, respectively, that are defined to retrieve planning data 200 from the planning application 204 and transfer the retrieved planning data 200 to the enterprise application module 206. The data transfer methods 224, 226, 228, or 230 may be defined to retrieve different portions of the planning data 200 from the planning application 204 and transfer the retrieved portions of planning data 200 to one or more enterprise applications 208 and 210 or one or more sub-modules 212, 214, 216, and 218 of the ERP application 208 in the enterprise application module 206.

In one example provided with respect to FIG. 1, it could be assumed that the data transfer framework 202 includes a “data transfer” option that includes two data transfer methods “TRANSFER_METHOD_QUANTITY” and “TRANSFER_METHOD_COST”. The “TRANSFER_METHOD_QUANTITY” is defined to retrieve a portion of the planning data 200, e.g., resources (“construction workers” and “building material”) and the resource quantity (“100 work hours” and “20000 pieces”), and transfer this portion of planning data 200 to a PS sub-module 212 in the ERP application 208. Further, it could be assumed that the planning application 204 also receive cost (1000$) to hire “construction workers” for “100 work hours” and cost (300$) to buy “20000 pieces” of building material. In this case, the “TRANSFER_METHOD_COST” may be defined to retrieve this portion of planning data 200 (e.g., 1000$ and 300$) from the planning application 204 and transfer planning data to a control (CO) sub-module 214.

In one embodiment, the data transfer methods 224, 226, 228, and 230 may include a data transfer implementation class 232, 234, 236 and 238, respectively, that contains data transfer logic for transferring the planning data 200 to one or more enterprise applications 208 and 210 or one or more sub-modules 212, 214, 216, and 218 of the ERP application 208 in the enterprise application module 206. In one embodiment, the data transfer implementation class 232, 234, 236, and 238 may be defined to call application program interface (API) that updates one or more enterprise applications 208 or 210 or one or more sub-modules 212, 214, 216, and 218 of the ERP application 208 in the enterprise application module 206. In the example described in the previous paragraph, the “TRANSFER_METHOD_COST” method may include a data transfer implementation class “TRANSFER_CLASS_CO”, which is defined to transfer the cost planning data to the CO sub-module 214 of the ERP application 208.

In one embodiment, the planning application 204 includes a plan header 240 that provides several options for transferring planning data 200. For example, the plan header 240 may provide a “transfer” option that triggers the transfer of planning data 200 from the planning application 204 to the enterprise application module 206. In one embodiment, the plan header 240 may also provide a “simulate” option. The “simulate” option if selected displays error, if any, which would occur if the planning data 200 is transferred to the enterprise application module 206. During the “simulate” operation there may be no actual transfer of planning data 200 from the planning application 204 to the enterprise application module 206. A simulation log could also be provided to store the result, success or failure, of transfer simulation. In one embodiment, the plan header 240 may also include a “transfer sync status” option, which indicates whether the last transferred planning data 200 is the latest planning data 200 in the planning application 204. The “transfer sync status” allows a user to ensure that enterprise application module 206 is updated with the latest planning data.

In one embodiment, when the “transfer” option in the plan header 240 is selected, then a data transfer execution engine 242 may execute one or more of the data transfer options 220 and 222 to transfer the planning data 200 to the enterprise application module 206. Executing one or more of the data transfer options 220 and 222 may include sequentially executing some or all of their data transfer methods 224, 226 and 228, 230, respectively. In the example described with respect to FIG. 1, the data transfer execution engine 242 may execute the “data transfer” option. Executing the “data transfer” option may include sequentially executing the methods TRANSFER_METHOD_QUANTITY” and “TRANSFER_METHOD_COST”, respectively, to retrieve and transfer the quantity and cost information.

In one embodiment, the data transfer framework 202 may transfer planning data 200 from the planning application 204 to the enterprise application module 206 without any human intervention. For example, the data transfer framework may check if there is any change in planning data 200 at the planning application 204. In case, there is a change in the planning data 200 at the planning application then the data transfer execution engine 242 may execute one or more of the data transfer options 220 and 222 to transfer the changed portion of planning data 200 to the enterprise application module 206.

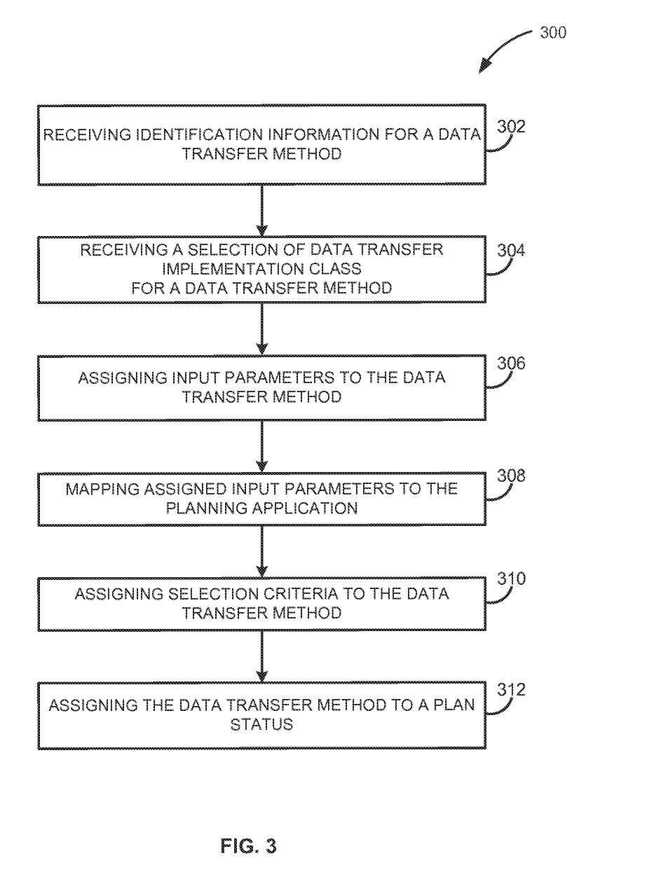

FIG. 3 is a flow diagram illustrating process 300 for defining a data transfer method, according to an embodiment. In one embodiment, a data transfer method is defined to receive a portion of planning data from a planning application and transfer the retrieved planning data to one or more enterprise applications or one or more sub-modules of one or more enterprise applications. For defining the data transfer method, initially, at 302, identification information for a data transfer method may be received. The identification information may include a name and a description for the transfer method. For example, a user may define a data transfer method by providing name “TRANSFER_METHOD_COST” and description “TRANSFER METHOD FOR UPDATING COST.”

Next at 304, a selection of data transfer implementation class may be received for the data transfer method. A data transfer implementation class includes logic to call one or more APIs that can transfer the planning data to one or more enterprise applications or one or more sub-modules in one or more applications, included, for example, in an enterprise application module. In one embodiment, a list of data transfer implementation classes is provided to a user, e.g., on a display. A user may select one of the data transfer implementation classes, from the list, for the data transfer method. The list of data transfer implementation classes may include system provided data transfer implementation classes and/or user defined data transfer implementation classes. A system provided data transfer implementation class is pre-defined to transfer planning data to the one or more applications or the one of the sub-modules of the one or more applications. For example, a system provided data transfer implementation class may be pre-defined to transfer the planning data to a control (CO) sub-module of an ERP application. In a user-defined data transfer implementation class the user may define the one or more planning applications or the one or more sub-modules of the one or more applications to which the user wants the planning data to be transferred. In this case, the user defines the logic, for the data transfer implementation class, to call the one or more APIs that transfer planning data to the one or more applications or to the one or more sub-modules of the one or more a applications. For example, the user may be provided three different data transfer implementation classes “quantity_data_transfer implementation_class”, “cost_data_transfer_implementation_class”, and “revenue_data_transfer_implementation_class”. The user may select the ““cost_data_transfer implementation_class”, for the data transfer method “TRANSFER_METHOD_COST”, which may be defined to transfer “cost” planning data (1000$ and 300$) to the CO sub-module of the ERP application.

In one embodiment, the selected data transfer implementation class also includes a data format that may define the format in which the retrieved planning data is to be transferred to the enterprise application module. For example, a planning application may include planning data with planning parameters “resource type”, “resource”, “currency”, and “user name”. The planning data, to be transferred to the enterprise application may be “resource” and “user name.” In this case, the data format may define that the planning data is to be transferred in a table format with two columns that include planning parameters “resource” and “user name” and rows with data values corresponding to the planning parameters. The planning data may be transferred to the enterprise application module in the define data format.

Next, at 306, one or more input parameters may be assigned to the data transfer method. The input parameters are assigned, to the data transfer method, for receiving planning data from the planning application. For example, an input parameter “RECEIVE_PLAN_COST” may be assigned to the data transfer method “TRANSFER_METHOD_COST” for receiving cost planning data (1000$ and 300$) from the planning application. At 308, the input parameters assigned to the data transfer method may be mapped to the planning application. Mapping the input parameters may define the source from where the planning data is to be received by the input parameters of the data transfer method. In one embodiment, the input parameters may be mapped to a line item level planning data, derived planning data, or fixed value. A line item level planning data may include, for example, a column in a row of a spreadsheet planning application from where the planning data is to be retrieved and provided to the input parameters. For example, the line item level planning data may be a data received at a cell of a Microsoft® Excel® planning application. The line item level planning data may include planning data received for several planning parameters, for example, resource type, resource, controlling area, currency, etc., at the planning application.

In one embodiment, the input parameters may be mapped to a derived planning data. Derived planning data includes planning data stored in organization identification (organization id) information of a project plan. The organization id information stores global values, for example, cost center, controlling area, etc., related to the plan. The input parameters may be mapped to one or more of the global values included in the organization id information of a plan. The input parameters of the data transfer method may also be mapped to a fixed value. In this case, the input parameters of the data transfer method may receive a fixed value, without retrieving the planning data from the planning application. For example, if a user is planning a US specific project then the country information “US” is a fixed value. In this case, an input parameter “country” of the data transfer method may be mapped to the fixed value “US”. During planning data transfer, the “country” input parameter may always be assigned a planning data “US” without retrieving planning data from the planning application.

In one embodiment, several selections may be provided for processing the planning data received by input parameters assigned to the data transfer method. For example, a sign reversal selection may be provided that reverses the sign of the planning data. The sign reversal selection may be selected for an input parameter assigned to the data transfer method. In case, a sign reversal selection is selected for a particular input parameter then the sign of the planning data received, by the input parameter, is reversed and then the reversed planning data is transferred to the enterprise application module. For example, an input parameter may be mapped to retrieve “revenue” information from planning application and the sign reversal selection may be selected. In this case if the “revenue” data is +35 in the planning application, then after sign reversal a revenue value −35 is transferred to the enterprise application module.

Next at 310, one or more selection criteria may be assigned to the data transfer method. Selection criteria may be filters that filter the planning data retrieved from the planning application, based on parameters included in the selection criteria. The parameters may include, for example, object type of project objects or resources type of resources selected for executing the project. For example, WBS “object type” parameter may be assigned to the “TRANSFER_METHOD_COST” data transfer method. In this case, planning data retrieved by the “TRANSFER_METHOD_COST” is filtered to provide project objects of WBS “object type” only.

Finally at 312, the data transfer implementation class may be assigned to a plan status. In one embodiment, a plan may have different status depending on the progress of the plan. For example, the plan status may be “new”, at the beginning of the plan, may be “in process” when the plan is being processed, and may be “completed” after completion of the planning. For example, the “TRANSFER_METHOD_COST” may be assigned to a plan status “in process”. The process in 302-312 may be repeated to define several data transfer methods.

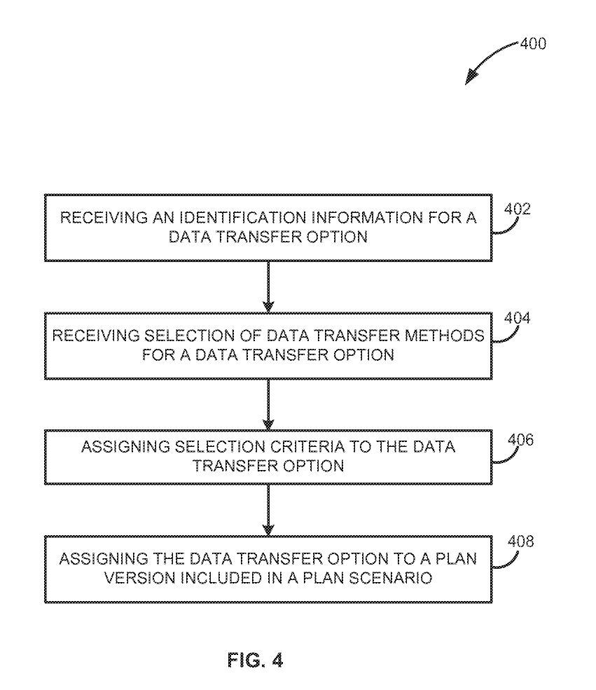

FIG. 4 is a flow diagram illustrating process 400 to define a data transfer option, according to an embodiment. A data transfer option is a collection of data transfer methods that are defined to retrieve planning data from the planning application and then transfer the planning data to the enterprise application module. Initially, at 402, identification information may be received for the data transfer option. The identification information may include a name and a description for the data transfer option. For example, a user may define a data transfer option by providing a name “TRANSFER_OPTION_CONSTRUCTION” for the data transfer option and a description “TRANSFER OPTION FOR UPDATING COST AND REVENUE.”

Next, at 404, a selection of data transfer methods is received for the data transfer option. In one embodiment, a user may be provided a list of data transfer methods. The user may select one or more data transfer methods from the list of data transfer methods displayed in a user interface. For example, for the option “TRANSFER_OPTION_CONSTRUCTION.” the user may select two data transfer methods “TRANSFER_METHOD_COST” and “TRANSFER_METHOD_REVENUE”, defined to retrieved cost and revenue planning data, respectively, from the planning application.

At 406, selection criteria may be assigned to the data transfer option. Similar to the selection criteria assigned to the data transfer method at 310 of FIG. 3, the selection criteria assigned to the data transfer option filters the planning data retrieved by the data transfer methods included in the data transfer option. For example a selection criteria assigned to a “TRANSFER_OPTION_CONSTRUCTION” option may be “change request ID”, which is set when planning data for a particular planning parameter has changed. “Cost” planning data (for example, 1000$) and “revenue” planning data (for example 350$) may be transferred by methods “TRANSFER_METHOD_COST” and “TRANSFER_METHOD_REVENUE”, respectively, and the “cost” planning data may be changed afterwards to 3000$ whereas the “revenue” planning data may remain unchanged. In this case, the selection criteria “change request ID” assigned for the “cost” and “revenue” planning data filters out the “revenue” planning data. The changed “cost” planning data 3000S, obtained after the filtering, is transferred to the enterprise application module.

At 408, the defined data transfer option may be assigned to a plan version included in a plan scenario. The data transfer option may be assigned to a plan version of a plan defined for the project. A plan scenario defines a particular functional area for which the plan is created. Planning scenario defines various planning constraints depending on the functional area for which the plan is defined. For example, a “construction” planning scenario may define that for a construction project the planning resources suggested should not include software developers. In one embodiment, plan versions include different versions of the plan created by the user. In the above example, a user can generate a first version of the plan based on actual values, by providing actual quantity of building material and actual number of human hours for the construction workers, required for executing the “campus construction” project. The user can also generate a second version of the plan by providing projected quantity of building material and projected number of human hours for the construction workers required for executing the project. In the above example, the “TRANSFER_OPTION_CONSTRUCTION” option may be assigned to the plan version 1, which is based on the actual planning data, included in the “construction” planning scenario. In one embodiment, the defining of the data transfer method in FIG. 3 and defining of the data transfer option in FIG. 4 may be performed at design time.

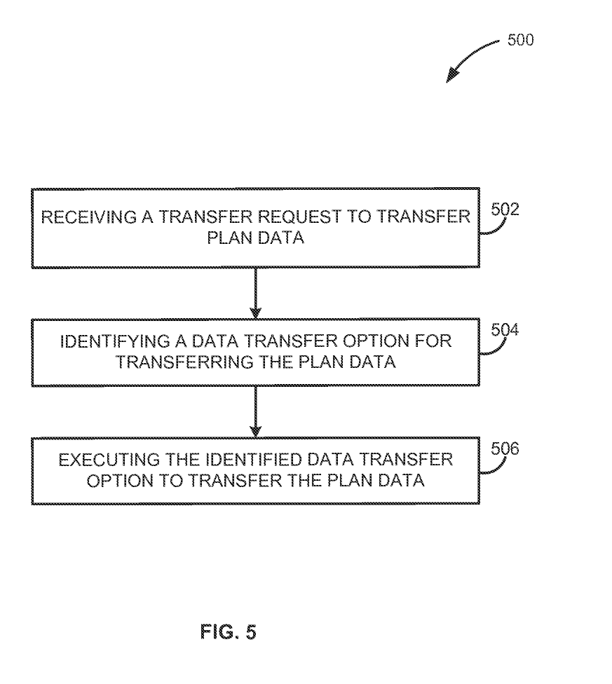

FIG. 5 is a flow diagram illustrating process 500 for transferring planning data, according to an embodiment. Initially, at 502 a transfer request is received at the planning application to transfer planning data from planning application to enterprise application module. A user may select a transfer option, provided in the planning application header, to initiate the transfer of planning data from the planning application to the enterprise application module. Next, at 504, a transfer option is identified for performing the transfer operation. The transfer option may be identified based on the planning scenario and plan version of the plan, for which the transfer request is received. In one embodiment, a data transfer execution engine identifies the data transfer option, from a number of different transfer options stored in the system, based on the plan scenario and plan version of the plan for which the transfer request has been received. In the example provided in the context of FIG. 4, when a transfer request is received at the planning application, based on the “construction” plan scenario and the “version 1” plan version of the plan, the “TRANSFER_OPTION_CONSTRUCTION” option may be selected.

Finally, at 506, the identified data transfer option is executed to transfer the planning data from the planning application to the enterprise application module. For example, the “TRANSFER_OPTION_CONSTRUCTION” option is executed to transfer the “cost” planning data and the “revenue” planning data to the enterprise application module.

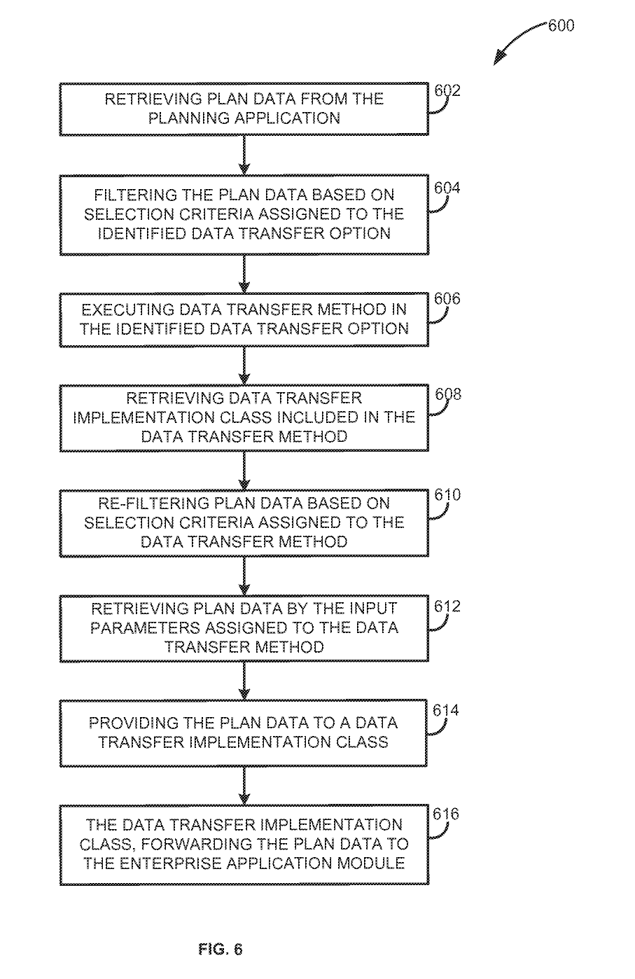

FIG. 6 is a detailed flow diagram illustrating process 600 of transferring planning data by identified data transfer option, according to an embodiment. Initially at 602, planning data from the planning application is retrieved. In one embodiment, a plan version assigned to the data transfer option is identified. The planning data included in this plan version of the plan is transferred to the data transfer framework. In the example provided in context of FIG. 4, the planning data stored in plan version 1, corresponding to the “TRANSFER_OPTION_CONSTRUCTION” transfer option, is transferred to the data transfer framework. Next at 604, the retrieved planning data is filtered based on a selection criteria assigned to the identified data transfer option. For example, the planning data may be filtered based on the selection criteria “change request id” assigned to the “TRANSFER_OPTION_CONSTRUCTION” transfer option.

Next at 606, data transfer method included in the data transfer option may be executed. The data transfer option, e.g., as identified at block 504 of FIG. 5, may include several data transfer methods that may transfer planning data from the planning application to the enterprise application module. Executing the identified data transfer option, e.g., as at block 506 of FIG. 5, may include sequential execution of the data transfer methods included in the identified data transfer option (at 606). In one embodiment, the data transfer method in the identified data transfer option may be retrieved. A check may then be performed to determine if the plan status assigned to the data transfer method is same as the plan status of the plan version of the plan assigned to the data transfer option. The data transfer method may be executed when the plan status assigned to the data transfer method is same as the plan status of the plan version. For example, “TRANSFER_METHOD_COST” transfer method and “TRANSFER_METHOD_REVENUE” transfer method may be included in “TRANSFER_OPTION_CONSTRUCTION” transfer option and may be assigned to a plan status “in progress”. In this case, the “TRANSFER_METHOD_COST” and “TRANSFER_METHOD_REVENUE” may be executed when the plan status of plan version 1 of “TRANSFER_OPTION_CONSTRUCTION” is “in progress”. The “TRANSFER_METHOD_COST” transfer method may be initially executed to transfer “cost” planning data to the enterprise application module. After executing the “TRANSFER_METHOD_COST” method. “TRANSFER_METHOD_REVENUE” transfer method included in “TRANSFER_OPTION_CONSTRUCTION” transfer option may be executed to transfer “revenue” planning data to the enterprise application module.

At 608, the data transfer implementation class included in the data transfer method has to be retrieved. The data transfer implementation class also includes a data format that may provide the format in which the planning data has to be transferred to enterprise application module. Next at 610, the filtered planning data obtained at block 602 may be re-filtered based on a selection criteria assigned to the identified transfer option (608). For example, the planning data may be re-filtered based on a selection criteria “WBS” object assigned to the “TRANSFER_METHOD_COST” transfer method.

Next at 612, input parameters assigned to the executed data transfer method may retrieve the planning data. In one embodiment, when the input parameters are mapped to a line item level data then the input parameters may retrieve the planning data from the filtered planning data obtained at 610. In case the input parameter is mapped to a derived planning data or a fixed value then the planning data may be retrieved from the planning application.

At 614, the planning data, obtained after filtering, e.g., at 604 and 610, is provided to a data transfer implementation class retrieved at block 608. In one embodiment, the planning data may be formatted based on data format included in the data transfer implementation class. The formatted planning data may then be provided to the data transfer implementation class included in the data transfer method. Finally at block 616, the data transfer implementation class may forward the planning data to the enterprise application module. In one embodiment, the data transfer implementation class includes transfer logic to call one or more APIs that transfer the planning data to one or more applications in the enterprise application module and/or to one or more sub-modules of the one or more applications in the enterprise application module. The execution of data transfer option described in FIG. 5 and the execution of the data transfer methods in FIG. 6, for transferring planning data, may be performed at run time. The transferring of planning data, by execution of data transfer option and the data transfer methods, may be performed without any human intervention.

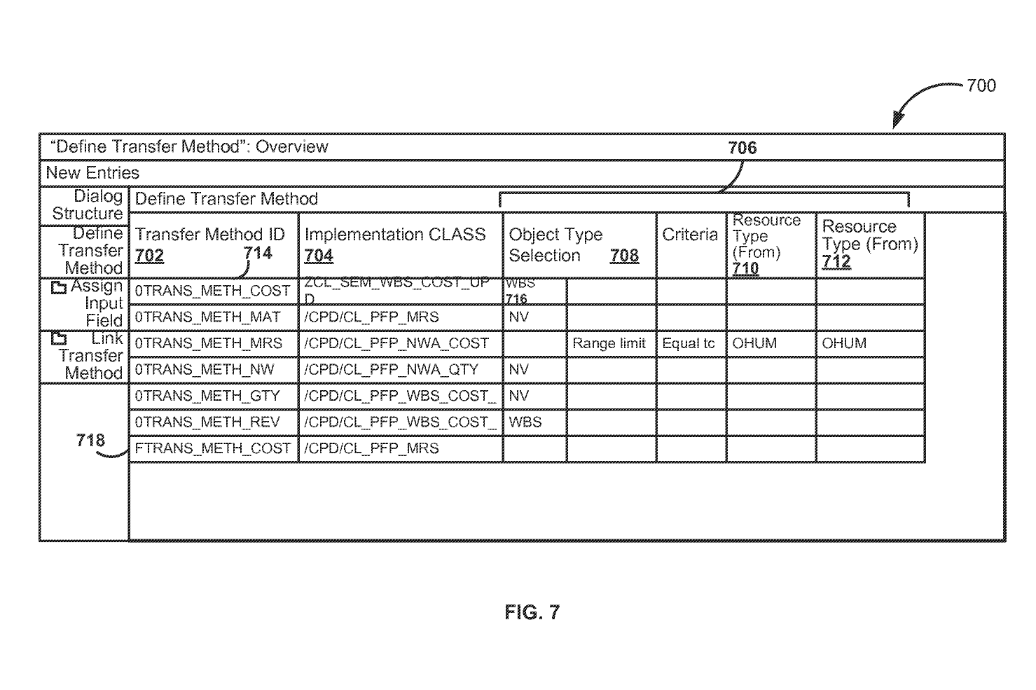

FIG. 7 illustrates an exemplary user interface screen 700 of an application for defining data transfer methods, according to an embodiment. In one embodiment, the application, is a data transfer framework defining application, which allows a user to define the data transfer methods and data transfer options. As shown, the financial planning application displays the different data transfer methods, represented by their data transfer method IDs 702. A user may then select implementation class 704 for each of the data transfer methods, represented by the data transfer method IDs 702. The selected implementation class 704 is assigned to the data transfer methods. The financial planning application may also allow a user to select selection criteria 706 for each of the data transfer methods represented by the data transfer method ID 702. The selection criteria 706, for filtering planning data, is based on two parameters “object type” 708 and “resource type” 710 and 712. For example, the data transfer method with transfer method id “0TRANS_METH_COST” 714 has been assigned a selection criteria “WBS” object type 716. In this case, if the transfer method with transfer method id “0TRANS_METH_COST” 714 receives three plan objects, two of object type “WBS” and one of object type “sales order”, then the planning data for only two plan objects, that have object type “WBS”, are transferred. In one embodiment, a selection criteria 706 may not be assigned to some of the transfer methods. For example, no selection criteria is assigned to transfer method with transfer method id “FTRANS_METH_COST” 718. In this case, the planning data retrieved by the input parameters of the transfer method with ID “FTRANS_METH_COST” 718 would not be filtered.

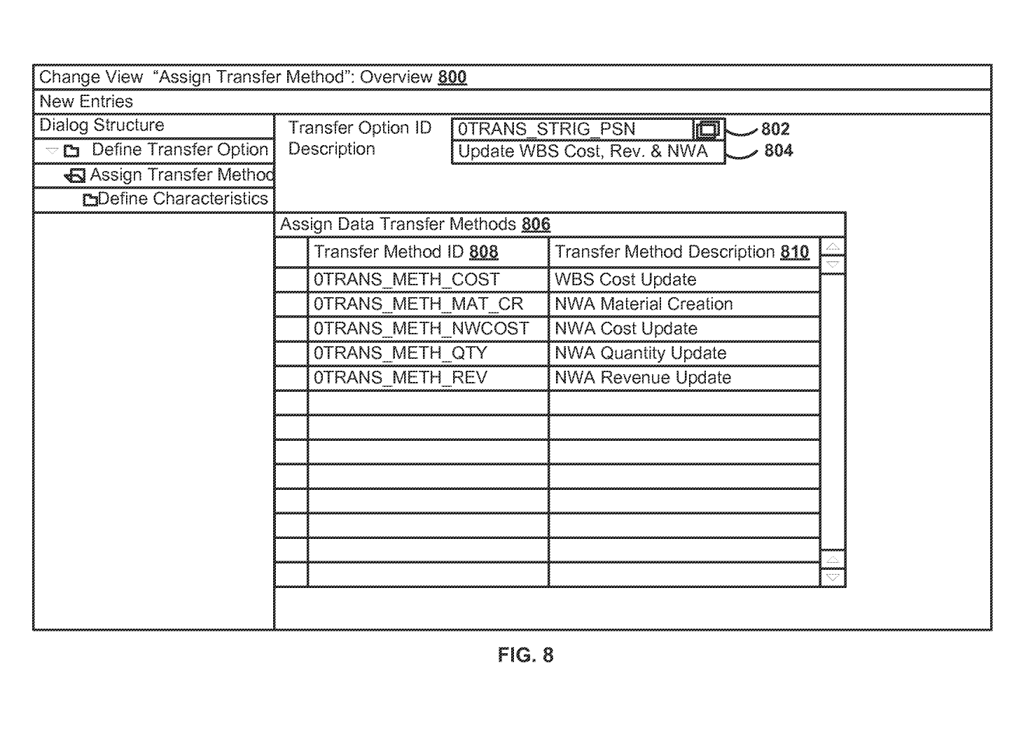

FIG. 8 illustrates an exemplary user interface screen 800 of an application for defining a data transfer option, according to an embodiment. The application may be the data transfer framework defining application. In one embodiment, the user provides a name identifier (ID) 802 and a description 804 for defining the data transfer option at the user interface screen 800. As shown, the user provides the data transfer option ID 802 as “0TRANS_STRIG_PSN” and the description 804 as “Update WBS_COST, Rev. & NWA.” The user may then assign data transfer methods 806 to the data transfer option. In one embodiment, the user provides a data transfer method ID 808 and a data transfer method description 810, of the data transfer methods that are to be assigned to the “data transfer option” for defining the data transfer option.

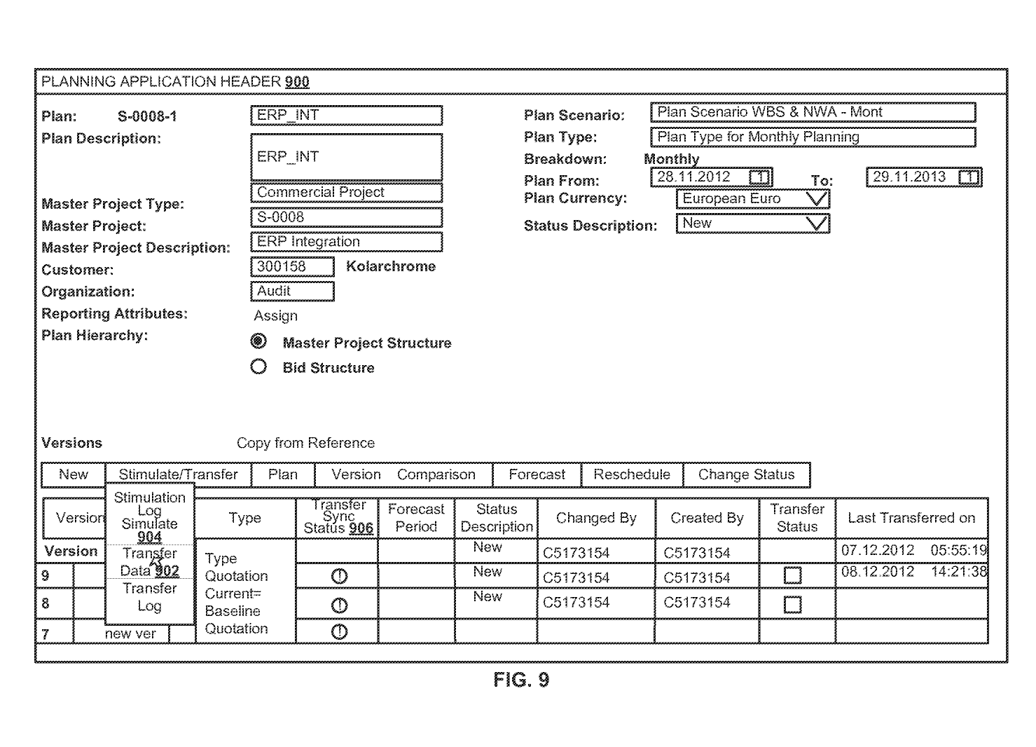

FIG. 9 illustrates a planning application header 900 including options to transfer planning data, according to an embodiment. The planning application header 900 includes a “transfer data” option 902, which when selected triggers the transfer of planning data in the planning application to the enterprise application module. In addition to “transfer data” 902 the plan header has a “simulate” option 904 that allows a user to check whether the planning data would be transferred successfully. When the “simulate” option 904 is selected then the system checks whether an error would occur if the planning data is transferred. In one embodiment, the plan header also includes a “transfer sync status” 906, which indicates whether the last transferred planning data is in sync with the planning data in the planning application. The “transfer sync status” 906 allows a user to ensure that planning data the enterprise application module is updated with the latest planning data.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

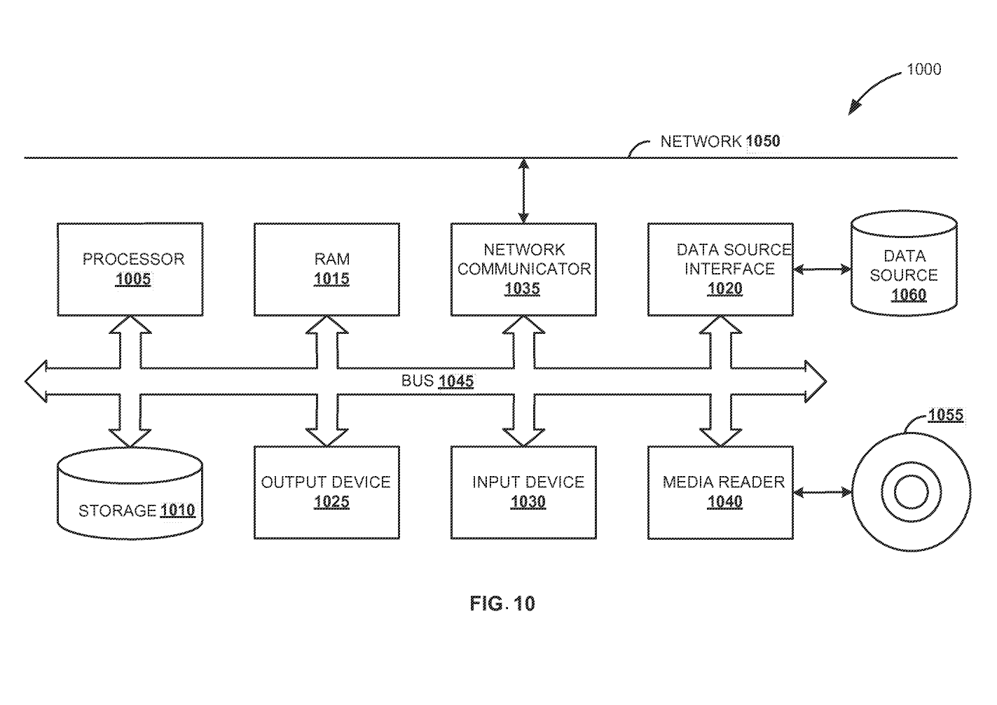

FIG. 10 is a block diagram of an exemplary computer system 1000. The computer system 1000 includes a processor 1005 that executes software instructions or code stored on a computer readable storage medium 1055 to perform the above-illustrated methods. The processor 1005 can include a plurality of cores. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. According to some embodiments, such as some in-memory computing system embodiments, the RAM 1015 can have sufficient storage capacity to store much of the data required for processing in the RAM 1015 instead of in the storage 1010. In some embodiments, all of the data required for processing may be stored in the RAM 1015. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to transfer planning data, the method comprising:
at a planning application, receiving a planning data transfer request to transfer the planning data included in the planning application;
based on the received request, identifying, by a processor of a computer, a data transfer option, from a plurality of data transfer options, to transfer the planning data; and
executing, by the processor of the computer, the identified data transfer option to transfer the planning data to an enterprise application module.

2. The computer implemented method of claim 1, further comprising:
receiving, at a user interface of the computer, a selection of a data transfer implementation class defined to transfer the planning data to the enterprise application module;
assigning, by the processor of the computer, the selected data transfer implementation class to a data transfer method defined to retrieve planning data from the planning application; and
receiving, at the user interface of the computer, a selection of the data transfer method for the data transfer option.

3. The computer implemented method of claim 2, wherein executing the identified data transfer option comprises:
executing, by the processor of the computer, the selected data transfer method for the data transfer option;
based on the execution, retrieving, by the processor of the computer, the planning data from the planning application;
forwarding, by the processor of the computer, the retrieved planning data to the data transfer implementation class assigned to the data transfer method; and
forwarding the planning data to the enterprise application module.

4. The computer implemented method of claim 3, further comprising:
filtering, by the processor of the computer, the retrieved planning data based on a selection criteria assigned to the data transfer method.

5. The computer implemented method of claim 3, further comprising:
filtering, by the processor of the computer, the planning data based on a selection criteria assigned to a data transfer method included in the data transfer option.

6. The computer implemented method of claim 1, further comprising:
assigning, by the processor of the computer, the data transfer option to a plan version of a project plan including the planning data.

7. The computer implemented method of claim 6, wherein identifying the data transfer option comprises:
based on the plan version of the plan, identifying, by the processor of the computer, the data transfer option to transfer the planning data.

8. The computer implemented method of claim 1, wherein executing the data transfer option comprises transferring the planning data to one or more enterprise applications in the enterprise application module.

9. The computer implemented method of claim 1, wherein executing the data transfer option comprises transferring the planning data to one or more sub-modules of an enterprise application included in the enterprise application module.

10. An article of manufacture including a computer readable storage medium to tangibly store instructions, which when executed by a computer, cause the computer to:
receive a planning data transfer request to transfer a planning data included in a planning application;
based on the received request, identify a data transfer option, from a plurality of data transfer options, to transfer the planning data; and
execute the identified data transfer option to transfer the planning data to an enterprise application module.

11. The article of manufacture according to claim 10, further comprising instructions which when executed by the computer further causes the computer to:
receive a selection of a data transfer implementation class defined to transfer the planning data to the enterprise application module;
assign the selected data transfer implementation class to a data transfer method defined to retrieve planning data from the planning application; and
receive a selection of the data transfer method for the data transfer option.

12. The article of manufacture according to claim 11, further comprising instructions which when executed by the computer further causes the computer to:
execute the selected data transfer method included in the data transfer option;
based on the execution, retrieve the planning data from the planning application;
forward the retrieved plan to the data transfer implementation class assigned to the data transfer method; and
the transfer implementation class, forwards the planning data to the enterprise application module.

13. The article of manufacture according to claim 12, further comprising instructions which when executed by the computer further causes the computer to:
filter, the retrieved planning data based on a selection criteria assigned to the data transfer method.

14. The article of manufacture according to claim 12, further comprising instructions which when executed by the computer further causes the computer to:
filter the planning data based on a selection criteria assigned to a data transfer method included in the data transfer option.

15. A computer system for transferring planning data, the computer system comprising:
a memory to store a program code; and
a processor communicatively coupled to the memory, the processor configured to execute the program code to:
receive a planning data transfer request to transfer the planning data included in a planning application;
based on the received request, identify a data transfer option, from a plurality of data transfer options, to transfer the planning data; and
execute the identified data transfer option to transfer the planning data to an enterprise application module.

16. The system of claim 15, wherein the processor further executes the program code to:
receive a selection of a data transfer implementation class defined to transfer the planning data to the enterprise application module;
assign the selected data transfer implementation class to a data transfer method defined to retrieve planning data from the planning application; and
receive a selection of the data transfer method for the data transfer option.

17. The system of claim 16, wherein the processor further executes the program code to:
execute the selected data transfer method included in the data transfer option;
based on the execution, retrieve the planning data from the planning application;
forward the retrieved plan to the data transfer implementation class assigned to the data transfer method; and
the transfer implementation class, forwards the planning data to the enterprise application module.

18. The system of claim 17, wherein the processor further executes the program code to:
filter, the retrieved planning data based on a selection criteria assigned to the data transfer method.

19. A data transfer framework to transfer planning data, the data transfer framework comprising:
a data transfer option in communication with a planning application, the data transfer option including:
a data transfer method defined to retrieve the planning data from the planning application, the data transfer method transferring the retrieved planning data to an enterprise application module; and
a data transfer execution engine to execute the data transfer option for transferring the planning data to the enterprise application module.

20. The data transfer framework of claim 19, wherein the data transfer method comprises:
a data transfer implementation class defined to transfer the received planning data to the enterprise application module.
